(19) United States
(12) Patent Application Publication
(10) Pub. No.: US 2008/0083304 A1
(43) Pub. Date: Apr. 10, 2008

(54) COMBINATION TOOL WITH A MULTI-FUNCTIONAL CASE

(76) Inventor: Patrick W. Finn, Joliet, IL (US)

Correspondence Address: Mathew R. P. Perrone Jr.;Brie A. Crawford, 210 South Main Street, Algonguin, IL, 60102, US

(21) Appl. No.: 11/539,629

(22) Filed: Oct. 7, 2006

(51) Int. Cl. B25B 13/46; B25G 1/08; B65D 85/28; B25B 23/16

(52) U.S. Cl. 81/177.4; 206/372; 206/375; 81/60

(57) ABSTRACT

A combination tool has a tool support which fits into a case for use and storage, while the case both stores bits for use with the tool support and provides a handle to facilitate the use of the tool support, in order to provide a compact, flexible and useful combination tool.

This invention relates to a combination tool and more particularly to a combination tool, which has removable bits secured in a multi-functional case, wherein the case may also serve as a handle for the tool driver.

### BACKGROUND OF THE INVENTION

Compactness and utility are desired features for a tool. Furthermore, if the tool is compact and can provide a wide variety of functions, even greater advantages are obtained. However, if a tool is compact, that tool may be difficult to grip and to use. Also, a compact tool does not usually have a variety of functions. Thus, compactness and utility work against each other in the art of tool design.

It is highly desirable to provide combination tools. However, use of combination tools can result in a complicated set up which destroys the efficiency of the tool involved. Also, it is highly desirable for a compound tool to be easily used with other components and easily transferred from the use of one element of the compound tool to another element, while at the same retaining the effectiveness of each individual tool.

Furthermore, there is great difficulty in having the elements locked into position for efficient use of each element of the compound tool. If the locking of the desired tool into position, cannot be accomplished efficiently, the tool lacks the required effectiveness.

The locking devices of the prior art are cumbersome. There is often difficulty in operating the locking device while in the act of using the pliers as a screwdriver or other tool. U.S. Pat. No. 6,167,581, by the same inventor, addresses these issues and is incorporated herein by reference.

### SUMMARY OF THE INVENTION

Therefore, among the many objectives of this invention is to provide a combination tool, which is easily adapted to support the use of an additional tool.

A further objective of this invention is to provide a combination tool, which is adapted in a simple manner.

A still further objective of this invention is to provide a combination tool adaptable to be locked with one hand for using another tool.

Yet a further objective of this invention is to provide a combination tool adaptable with a Phillips screw driver tip.

Also, an objective of this invention is to provide a combination tool adaptable with a flat or blade screw driver tip.

Another objective of this invention is to provide a combination tool adaptable with a star screw driver tip.

Yet another objective of this invention is to provide a combination tool adaptable with an Allen wrench tip.

Still, another objective of this invention is to provide a combination tool adaptable with a scribe tip.

A further objective of this invention is to provide a combination tool adaptable with a square tip.

A still further objective of this invention is to provide a combination tool adaptable with a socket drive tip.

These and other objectives of the invention (which other objectives become clear by consideration of the specification, claims and drawings as a whole) are met by providing a combination tool wherein a tool support fits into a case for use and storage, while the case also stores bits for use with the tool support.

### BRIEF DESCRIPTION OF DRAWINGS

FIG. 1 depicts a block diagram for ratchet combination tool kit 100.

FIG. 2 depicts a top perspective view of ratchet combination tool kit 100 with ratchet case 120 being in open position 122 and ratchet drive 170 extending out.

FIG. 3 depicts a top perspective view of ratchet combination tool kit 100 with ratchet case 120 being in open position 122 and straight hex socket 172 extending out.

FIG. 4 depicts a top perspective view of ratchet case 120 in open position 122 with side hinge 148.

FIG. 5 depicts a side perspective view of ratchet case 120 in open position 122 with back hinge 149.

FIG. 6 depicts a side perspective view of tool support 160.

FIG. 7 depicts a side perspective view of tool support 160 opposite of FIG. 6.

FIG. 8 depicts a perspective view of ratchet combination tool kit 100 in closed position 124 in order to provide handle grip 132, and with straight hex socket 172 in use.

FIG. 9 depicts ratchet combination tool kit 100 in closed position 124 in order to provide handle grip 132 with hex socket 190 of ratchet drive 170 in use.

FIG. 10 depicts a perspective view of ratchet combination tool kit 100 in closed position 124 in order to provide handle grip 132 for tool support 160 with square drive 188 of ratchet drive 170 in use.

FIG. 11 depicts a block diagram of pliers combination tool kit 198.

FIG. 12 depicts a perspective view of pliers combination tool kit 198 with pliers tool bit 236.

FIG. 13 depicts a top view of pliers combination tool kit 198 with pliers case 196 in open position 122.

FIG. 14 depicts a block diagram of pliers combination tool kit 198.

FIG. 15 depicts a top view of pliers combination tool kit 198 with pliers case 196 in open position 122 and pliers 200 stored in vertical position 216.

FIG. 16 depicts a top view of pliers combination tool kit 198 with pliers case 196 in open position 122 and pliers 200 stored in horizontal position 206.

FIG. 17 depicts a block diagram of sliding combination tool kit 248 with locking button 258 and locking aperture 256.

FIG. 18 depicts a perspective view of sliding combination tool kit 248 with straight hex socket 172 in stored position 262 and sliding combination ratchet drive 266.

FIG. 19 depicts a perspective view of sliding combination tool kit 248 with sliding combination ratchet drive 266 in stored position 262 and sliding combination straight hex socket 268 in available position 260.

FIG. 20 depicts an exploded perspective view of sliding combination tool kit 248.

FIG. 21 depicts a perspective view of combination bit 186.

FIG. 22 depicts a block diagram of blind end combination tool kit 290 with blind end sliding sleeve 292.

FIG. 23 depicts a perspective view of blind end combination tool kit 290 with blind end sliding sleeve 292 with blind end ratchet drive 300 in resting position 314 and blind end straight hex socket 302 in usable position 316.

FIG. 24 depicts a perspective view of blind end combination tool kit 290 with blind end sliding sleeve 292 with blind end ratchet drive 300 in usable position 316.

FIG. 25 depicts a perspective view of blind end combination tool kit 290 with blind end hex socket 308 in usable position 316.

FIG. 26 depicts an exploded perspective view of blind end combination tool kit 290.

FIG. 27 depicts an exploded perspective view of blind end combination tool kit 290 with hexagonal tool support body 354 in reversed position of FIG. 26.

Throughout the figures of the drawings, where the same part appears in more than one figure of the drawings, the same number is applied thereto.

### DESCRIPTION OF THE PREFERRED EMBODIMENTS

The combination tool includes a case and a tool support, wherein the case and the tool support have a high degree of cooperation. The case both stores a selection of bits for the tool support and provides a handle to facilitate use of the tool support, with a desired bit thereon. More particularly the combination tool has removable bits secured in a multi-functional case, so the bits may be easily selected for use. Furthermore, the case includes support braces, so that the case may also serve as a handle for the tool support. In this fashion, the combination tool has great flexibility and use.

The tool support may be of any desired type. For example, at one end thereof may be a ratchet, while at the other end thereof may be a fixed driving head. Either end may receive any of the bits contained in the case. Also, the pliers, and described in the above-referenced patents to the same inventor, may be used as the tool support and contained in the case.

Throughout the drawings and the description of the preferred embodiments, the ratchet is shown as a reversible ratchet. However, any type of ratchet would be a suitable substitute for the reversible ratchet depicted in the drawings. For example, the ratchet can be a simple irreversible ratchet.

Many different types of bits may be contained in the case for use. Any number of tips may be used including a star tip, an Allen tip, a square tip, a socket drive tip, a Phillips tip, a blade tip, or a scribe tip. A socket set may also be contained therein.

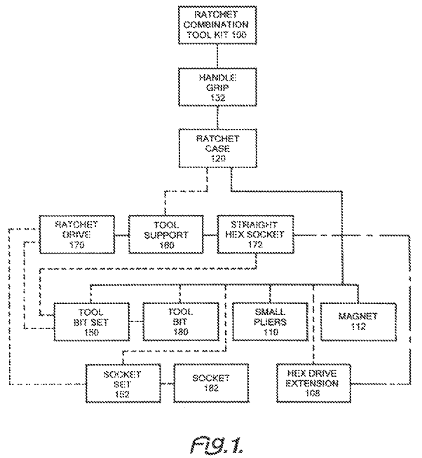

Referring now to FIG. 1, ratchet combination tool kit 100 has ratchet case 120 with tool support 160 mounted therein. Any desired tool bit 180 can be placed on tool support 160. Ratchet combination tool kit 100 has ratchet case 120. In ratchet case 120 is tool bit set 150, small pliers 110, socket set 152, hex drive extension 108, and magnet 112.

On ratchet case 120 is handle grip 132. With handle grip 132 in place, it simplifies the gripping of ratchet case 120 by hand 102 (as shown in FIG. 8) and the use thereof as a handle for tool support 160. With tool bit 180 on tool support 160, great advantages are thus achieved, due to the improved gripping. Into tool support 160 may be fitted any desired tool. For example, ratchet drive 170 may be secured in one end of tool support, while straight hex socket 172 may be placed in the other end of tool support 160.

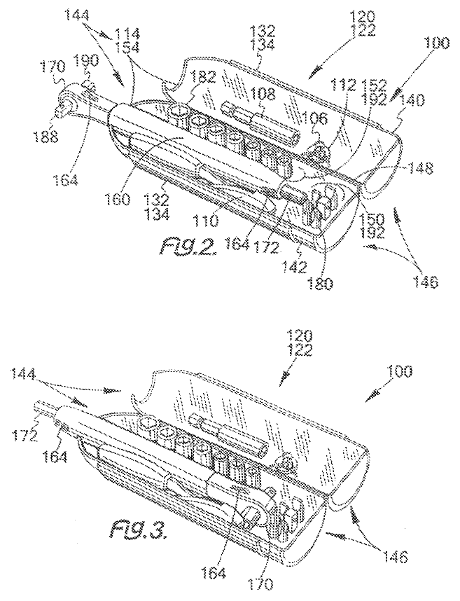

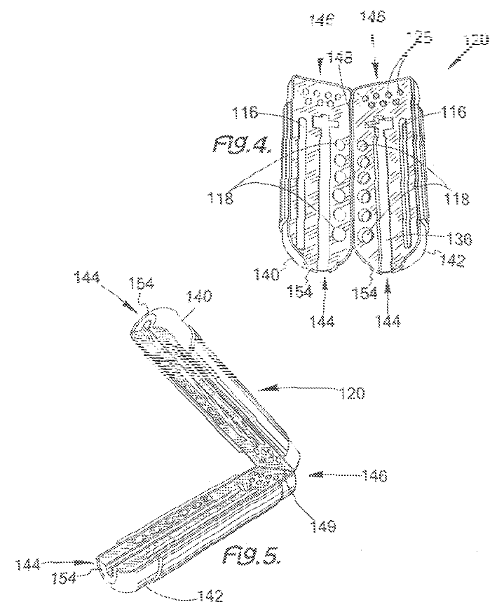

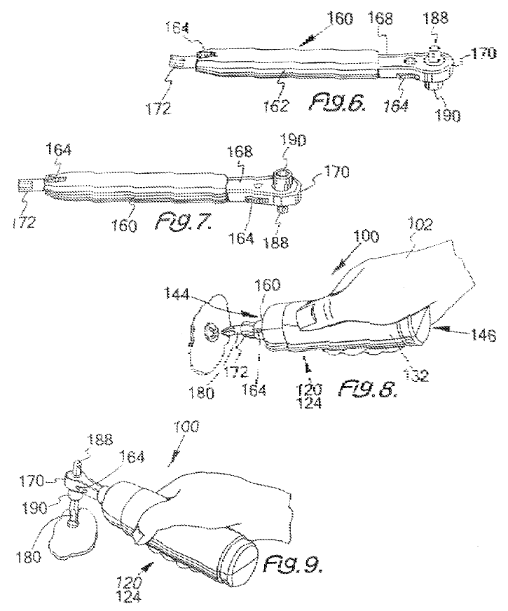

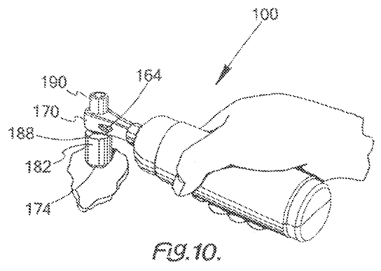

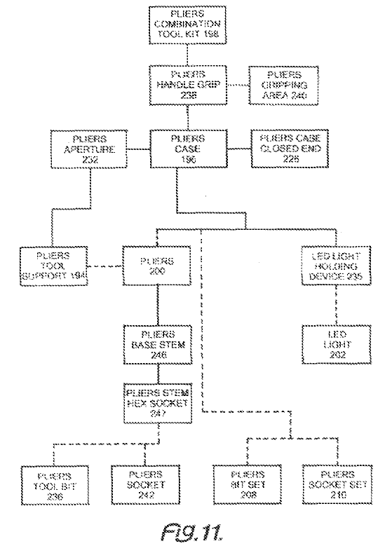

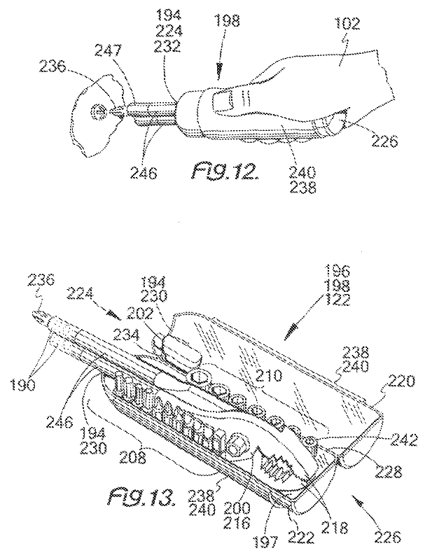

Adding FIG. 2, FIG. 3, FIG. 4, and FIG. 5 to the consideration, the structure of ratchet case 120 becomes more clear. Ratchet case 120 has top half 140 and base half 142. Top half 140 and base half 142 combine to appear to be generally cylindrical in shape and substantially symmetrical. Ratchet case 120 has open end 144 and closed end 146 with a hinge on the side thereof. A hinge joins top half 140 to base half 142. The hinge is either side hinge 148 or back hinge 149 (FIG. 5). Both top half 140 and base half 142 have arc 154 at open end 144 to provide a space for tool support 160 to pass therethrough.

Closed end 146 secures a collection of combination tool accessories 192 and tool support 160 therein. Inside of ratchet case 120, are a series of cavities which secure combination tool accessories 192 in place. Tool bits 180 are secured in place through bit cavity 126, usually by friction. Tool support 160 is secured into place through tool support cavity 136. While sockets 182 are held firmly in place through socket cavity 118. Small pliers 110 are secured through pliers cavity 116. Finally, fasteners or screws 106 are held into place through magnet 112.

Open end 144 provides for a passage through which an end of tool support 160 can extend from ratchet case 120 through tool aperture 114 formed at open end 144. This permits ratchet case 120 to be used efficiently as a handle. The extra support that is provided by tool support cavity 136 adds to the security and stability that is necessary for tool support 160 to be used as a tool. Handle grip 132 has gripping area 134 for hand 102 (as shown in FIG. 8) and further permits ratchet combination tool kit 100 to be used efficiently.

Adding FIG. 6 and FIG. 7 to the consideration, the structure of tool support 160 becomes clear. Tool support 160 includes central tubular portion 162. Into central tubular portion 162 may be fitted any desired tool. In the depicted embodiment, central tubular portion 162 receives reversible ratchet 164 and ratchet handle 168 leaving exposed ratchet drive 170. Ratchet drive 170 has one side with square drive 188 for receiving socket 182 while the other side has hex socket 190 for receiving tool bits 180. At the other end thereof straight hex socket 172 is mounted to receive tool bits 180.

With FIG. 8, FIG. 9, and FIG. 10 coming in to view, the flexibility of ratchet combination tool kit 100 becomes more clear. In these embodiments, ratchet case 120 is in closed position 124 and ratchet case 120 serves as handle grip 132. Ratchet case 120 can be applied to any desired tool, with the appropriate adjustment in tool support cavity 136. For example, FIG. 8 depicts ratchet case 120 applied to straight hex socket 172 which accommodates a variety of tool bits 180.

Then, FIG. 9 depicts ratchet case 120 applied to ratchet drive 170, square drive 188, and hex socket 190 which accommodates a variety of tool bits 180. Finally, FIG. 10 depicts ratchet drive 170, square drive 188 opposite of hex socket 190, driving socket 182 to turn bolt head 174 of ratchet combination tool kit 100. These are examples of the variety of attachments that are available for ratchet combination tool kit 100 but this list is not exhaustive and any suitable attachment can be applied to ratchet combination tool kit 100.

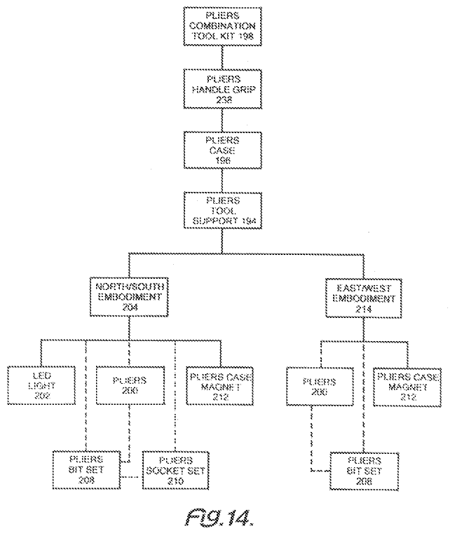

Adding FIG. 11, FIG. 12, and FIG. 13 to the consideration, the structure fo pliers combination tool kit 198 can be clearly seen. The structure of pliers tool support 194 has pliers 200 which have pliers base stems 246. Pliers base stems 246 serve dual purposes which are at opposite end of pliers jaws 218. First, pliers base stems 246 provide the mechanism to open and close pliers jaws 218. Secondly, pliers base stems 246 also are pliers stem hex socket 247. The user attaches pliers tool bits 236 to pliers hex socket 247 of pliers base stems 246 in order to use pliers combination tool kit 198 for a variety of purposes.

The structure of pliers case 196 is similar to that of ratchet case 120. Pliers case 196 has pliers case top half 220 and pliers case base half 222. Pliers case top half 220 and pliers case base half 222 combine to form a generally cylindrical shape which is substantially symmetrical. Pliers case 196 has pliers case open end 224 and pliers case closed end 226 with pliers case hinge 228 on the side thereof. Pliers case hinge 228 joins pliers case top half 220 to pliers case base half 222. Both pliers case top half 220 and pliers case base half 222 have pliers case arc 230 and pliers case open end 224 to provide for pliers tool support 194 to pass therethrough.

Pliers case closed end 226 secures pliers tool bit set 208 and plier socket set 210 and pliers tool support 194 therein. Pliers case open end 224 provides for an end of pliers tool support 194 to extend from pliers case 196 through pliers aperture 232, and permits pliers case 196 to be used efficiently as a handle. Pliers handle grip 238 has pliers gripping area 240 for hand 102 and further permits pliers combination tool kit 198 to be used efficiently.

Pliers case 196 has a series of pliers case cavities, which are similar to pliers cavity 116, socket cavity 118, bit cavity 126, and tool support cavity 136 (all of which are depicted in FIG. 4 and FIG. 5). Pliers bit set 208, pliers socket set 210, and pliers 200 are securely held in place by pliers case cavities 197 (similar to pliers cavity 116 as shown in FIG. 4 and FIG. 5).

Furthermore, a light source such as light emitting diode or LED light 202 is stored inside pliers case 196. Inside pliers case 196 is LED light magnet 234 (as shown in FIG. 13). LED light 202 is held securely in place through LED light holding device 235. In the depicted embodiment, LED light 202 is held securely in place through its interaction with LED light magnet 234.

Another embodiment for LED light holding device 235 is a standard hook and loop assembly. A standard hook and loop assembly is available under the registered trademark VELCRO, owned by Velcro Industries B.V. LIMITED LIABILITY COMPANY NETHERLANDS Castorweg 22-24 Curacao NETHERLANDS ANTILLES. However, LED light holding device 235 can be any suitable attachment form such as a clip, piece of double sided tape, LED light cavity, or any other suitable holding device.

LED light 202 is used to illuminate pliers case 196 so that the user is able to easily find the desired pliers tool bit 236 or pliers socket 242. In this manner, LED light 202 also illuminates the outer vicinity of pliers case 196. In another alternative, LED light 202 is attached to pliers 200 or hex socket 190 through the magnetic force. Finally, LED light 202 is used separately from pliers combination tool kit 198 to illuminate the work area.

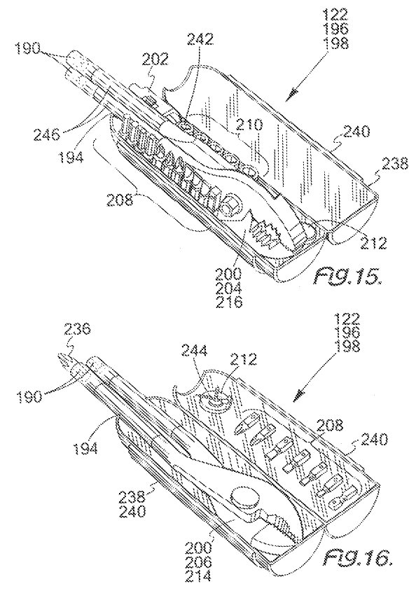

Adding FIG. 14, FIG. 15, and FIG. 16 to the consideration, two different configurations of pliers combination tool kit 198 are clearly seen. These configurations have pliers tool support 194 with pliers 200 resting therein. Hex socket 190 is designed to accommodate a variety of pliers tool bits 236.

Referring specifically to FIG. 15, North/South embodiment 204 can be clearly seen. In the North/South embodiment 204, pliers 200 rest in vertical position 216. In the preferred North/South embodiment 204, this vertical position 216 allows a multitude of pieces to be stored in pliers case 196. For example, pliers bit set 208, pliers socket set 210, LED light 202, pliers 200, and pliers case magnet 212 can all be stored in pliers case 196. Pliers case screws 244 (as shown in FIG. 16) are securely held in storage by pliers case magnet 212. However, other suitable elements may be substituted for those mentioned in this embodiment.

Referring specifically to FIG. 16, the arrangement of East/West embodiment 214 can be clearly seen. In East/West embodiment 214, pliers 200 rest in horizontal position 206. In the preferred embodiment, East/West embodiment 214 allows for storage of pliers bit set 208 and pliers case magnet 212 in pliers case 196. Pliers case screws 244, as well as other fasteners, may be securely held in storage by pliers case magnet 212. However, other suitable elements may be stored in pliers case 196 instead of those depicted.

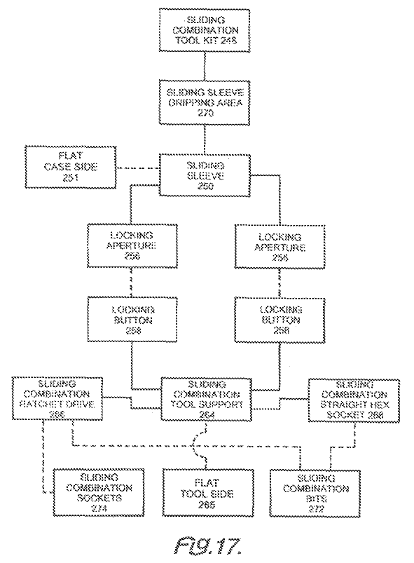

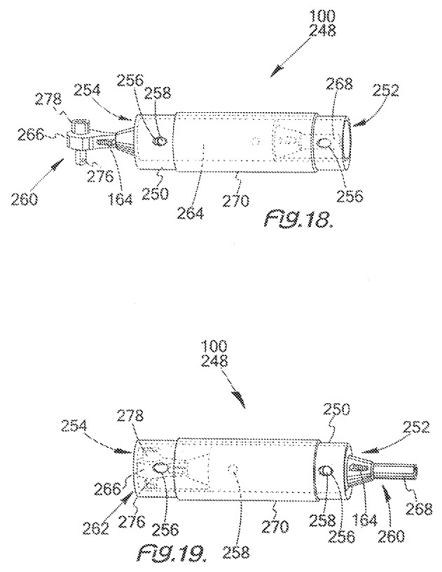

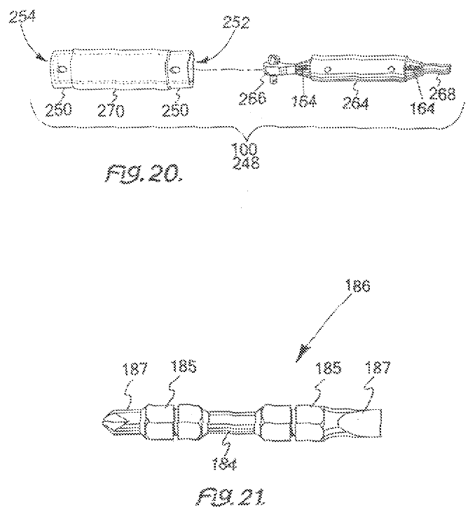

Further embodiments to ratchet combination tool kit 100 can be seen in FIG. 17, FIG. 18, FIG. 19, and FIG. 20. In sliding combination toolkit 248, ratchet case 120 is replaced by sliding sleeve 250. Sliding sleeve 250 is cylindrical in shape and is hollow on the inside. Sliding sleeve 250 additional has sliding sleeve gripping area 270 which adds to the efficiency of sliding combination toolkit 248.

On sliding sleeve 250, there are first open end 252, with second open end 254 being oppositely disposed therefrom. Sliding sleeve 250 also has locking apertures 256. Sliding combination tool support 264 is the second component of sliding combination toolkit 248. On one end of sliding combination tool support 264 is sliding combination ratchet drive 266.

If desired, sliding sleeve 250. Sliding sleeve 250 is cylindrical in shape and sliding combination tool support 264 can be modified. Sliding sleeve 250 may optionally have flat case side 251 to correspond with flat tool side 265 sliding combination tool support 264. Flat case side 251 cooperates with flat tool side 265, so that locking apertures 256 of sliding sleeve 250 more efficiently align with locking button 258 of combination tool support 264, and thereby more efficiently cooperate.

Sliding combination ratchet drive 266 has two components. First, sliding combination ratchet drive 266 has sliding combination square drive 276 which accommodates sliding combination sockets 274. Secondly, sliding combination ratchet drive 266 has sliding combination hex socket 278 which accommodates sliding combination bits 272.

While on the opposite end of sliding combination tool support 264 is sliding combination straight hex socket 268. Sliding combination straight hex socket 268 accommodates sliding combination bits 272. The diameter of sliding combination tool support 264 is less than the diameter of sliding sleeve 250. The length of sliding combination tool support 264 is proportioned so that either sliding combination ratchet drive 266 or sliding combination straight hex socket 268 may be placed in available position 260 while the other is in stored position 262.

Sliding combination tool support 264 cooperates with sliding sleeve 250. On sliding combination tool support 264 is locking button 258. As sliding combination tool support 264 is moving through sliding sleeve 250, locking buttons 258 are depressed due to the confinement within sliding sleeve 250. Once the desired end is in available position 260, locking buttons 258 align with locking aperture 256. This alignment causes locking buttons 258 to relax and push through locking aperture 256. This mechanism forms a secure position for the exposed tool.

Adding FIG. 21 to the consideration, the structure of combination bit 186 is clearly seen. In this particular embodiment, combination bit 186 is designed to fit in straight hex socket 172 or hex socket 190. However, a variety of different embodiments are suitable.

Combination bit 186 has bit body 184 which is cylindrical in shape. Attached to bit body 184 is hexagonal support 185. Hexagonal support 185 cooperates with straight hex socket 172 or hex socket 190 to form a secure and stable attachment. Hexagonal support 185 has bit head 18. Bit head 187 is any suitable shape or embodiment.

In this instance, combination bit 186 has a Phillips head at one end and a flat end on the other side. Combination bit 186 is placed in straight hex socket 172 or hex socket 190 which extends from tool support 160 (as shown in FIG. 8 and FIG. 9). Combination bit 186 is also placed in sliding combination hex socket 278 or sliding combination straight hex socket 268, which extends from sliding combination tool support 264 (as shown in FIG. 19).

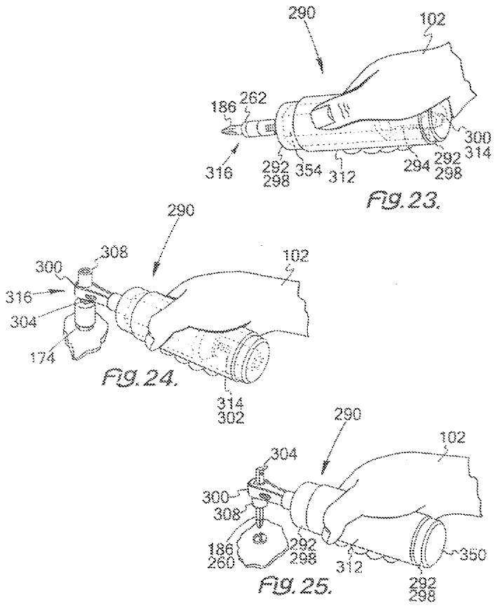

Finally, combination bit 186 is placed in blind end straight hex socket 302 or blind end hex socket 308 (as shown in FIG. 24) which extends from blind end tool support 298 (as shown in FIG. 23 and FIG. 25). As a result, one end of combination bit 186 is in available position 260 while the other end is in stored position 262.

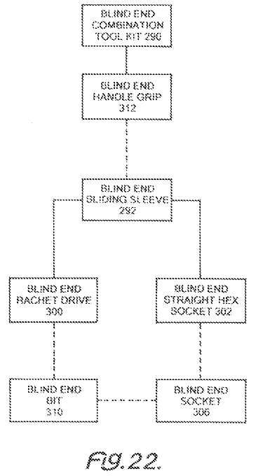

If the user needs to use the end in stored position 262, he removes combination bit 186 from straight hex socket 172 or hex socket 190 and inserts it back into straight hex socket 172 or hex socket 190 in the reverse direction. This allows ratchet combination tool kit 100, sliding combination tool kit 248, and blind end combination tool kit 290 (as shown in FIG. 22) to be utilized in a variety of different embodiments.

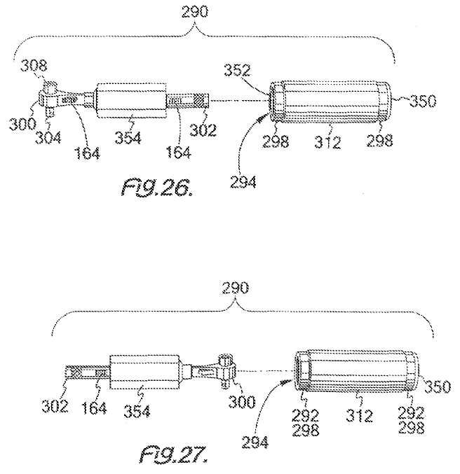

Adding FIG. 22, FIG. 23, FIG. 24, FIG. 25, FIG. 26, and FIG. 27 to the consideration, blind end combination tool kit 290 can be seen. In this embodiment, blind end sliding sleeve 292 has blind end 350 and blind end tool aperture 294. Blind end 350 is closed. Blind end sliding sleeve 292 is cylindrical in shape and is hollow on the inside. Blind end sliding sleeve 292 has blind end handle grip 312 which adds to the efficiency of blind end combination tool kit 290.

For blind end combination tool kit 290, blind end tool support 298 has hexagonal tool support body 354. On one end of hexagonal tool support body 354 is blind end ratchet drive 300. Blind end ratchet drive 300 has blind end square drive 304 which accommodates blind end sockets 306. Blind end ratchet drive 300 also has blind end hex socket 308 which accommodates blind end bits 310. Oppositely positioned from blind end ratchet drive 300 on hexagonal tool support body 354 is blind end straight hex socket 302. Blind end straight hex socket 302 accommodates blind end bits 310.

Blind end sliding sleeve 292 has inner lining 352 with a hexagonally shaped cross section. Inner lining 352 cooperates with hexagonal tool support body 354 to form a secure and stable attachment between the two. The length of blind end sliding sleeve 292 is long enough to accommodate hexagonal tool support body 354 and either blind end ratchet drive 300 or blind end straight hex socket 302. The diameter of blind end sliding sleeve 292 with inner lining 352 is wider than the diameter of hexagonal tool support body 354.

However, this diameter is still narrow enough to allow for a secure and stable attachment between blind end sliding sleeve 292 and hexagonal tool support body 354. The diameter of blind end ratchet drive 300 and blind end straight hex socket 302 is smaller than that of inner lining 352 so that they are able to be stored in blind end sliding sleeve 292.

Blind end sliding sleeve 292 also acts as blind end handle grip 312 for blind end combination tool kit 290 of this embodiment. Blind end sliding sleeve 292 has blind end handle grip 312 which allows blind end combination tool kit 290 to act more efficiently as a tool.

The user slides hexagonal tool support body 354 into blind end sliding sleeve 292 by aligning hexagonal tool support body 354 with inner lining 352. Blind end 350 stops the movement. Thus, leaving either blind end ratchet drive 300 or blind end straight hex socket 302 in usable position 316, while the other is in resting position 314. When the user wants to use the other end, that person slides hexagonal tool support body 354 out of blind end sliding sleeve 292 and slides hexagonal tool support body 354 back into blind end sliding sleeve 292 leaving the opposite end in usable position 316. Thus, blind end combination tool kit 290 provides a variety of tools in one combination which is easy and convenient to store and use.

This application—taken as a whole with the abstract, specification, claims, and drawings—provides sufficient information for a person having ordinary skill in the art to practice the invention disclosed and claimed herein. Any measures necessary to practice this invention are well within the skill of a person having ordinary skill in this art after that person has made a careful study of this disclosure.

Because of this disclosure and solely because of this disclosure, modification of this tool can become clear to a person having ordinary skill in this particular art. Such modifications are clearly covered by this disclosure.

What is claimed and sought to be protected by Letters Patent is:

1. A hinged combination tool kit having a case with a tool support comprising:
a) the case having the tool support adaptable for a tool driver and mounted within the case;
b) the case being hollow and adapted to store a variety of combination tool accessories;
c) the case having a handle grip on its exterior;
d) the case having a top half and a base half;
e) the top half and the base half being joined by a hinge; and
f) the tool support being adapted to cooperate with the variety of combination tool accessories.

2. The hinged combination tool kit of claim 1 further comprising:
a) the tool support being adapted to cooperate with the case being hollow and adapted to store a variety of combination tool accessories;
b) the top half and the base half being substantially symmetrical and combining in a generally cylindrical shape;
c) the case having a closed end and an open end; and
d) the top half and the base half having an arc at the open end to provide an aperture for the tool support to pass through.

3. The hinged combination tool kit of claim 2 further comprising:
a) the tool driver having a ratchet driver on at least one end thereof;
b) the closed end securing the combination tool accessories and the tool support with the case;
c) the case having a series of cavities to secure the tool support and the combination tool accessories within the case; and
d) the tool support having a central tubular portion which allows it to have a variety of tools mounted therein.

4. The hinged combination tool kit of claim 3 further comprising:
a) the case being a ratchet case and the ratchet case having the tool support mounted therein;
b) the central tubular portion of the tool support having a ratchet drive and a straight hex socket mounted into it; and
c) the ratchet drive having two oppositely disposed sides with one side having a square drive which receives sockets and the other side having a hex socket to receive bits.

5. The hinged combination tool kit of claim 4 further comprising the hinge being a side hinge.

6. The hinged combination tool kit of claim 4 further comprising the hinge being a back hinge.

7. A pliers combination tool kit mounted upon a pliers case comprising:
a) the pliers case having a pliers case top half and a pliers case base half;
b) the pliers case top half and the pliers case base half being joined by a pliers case hinge;
c) the pliers case top half and the pliers case base half being substantially symmetrical and joining in a generally cylindrical shape;
d) the pliers case having a pliers case open end and a pliers case closed end;
e) both the pliers case top half and the pliers case base half having a pliers case arc at the pliers case open end;
f) the pliers case open end providing an aperture for a pliers tool support to pass therethrough;
g) the closed end securing the pliers combination tool accessories and the pliers tool support with the pliers case;
h) the pliers case having a series of pliers case cavities to secure the pliers tool support and the pliers combination tool accessories within the pliers case; and
i) the pliers case having a magnet to secure additional pliers combination tool accessories within the pliers case.

8. The pliers combination tool kit of claim 7 further comprising:
a) the pliers combination tool accessories having a pliers case magnet which holds screws securely in place through their magnetic interaction;
b) the pliers combination tool kit having the pliers case in which the pliers are stored in a horizontal position;
c) the pliers case having a pliers bit set which is held securely in place through the pliers case cavities;
d) the pliers combination tool kit having a light source, which is held securely in place through a light holding device;
e) the pliers having pliers base stems which are capable of accommodating pliers combination tool accessories; and
f) the ratchet case having a handle grip on its exterior.

9. The pliers combination tool kit of claim 8 further comprising:
a) the light source including a light emitting diode, which is held securely in the pliers case through with a magnet;
b) the pliers combination tool kit having the pliers case in which the pliers are stored in a vertical position;
c) the pliers case having a pliers socket set which is held in place through the pliers case cavities;
d) the pliers case having a pliers bit set which is held in place through the pliers case cavities; and
e) the pliers case having a pliers case magnet which holds screws securely in place through their magnetic interaction.

10. The pliers combination tool kit of claim 9 further comprising the hinge being a side hinge.

11. The pliers combination tool kit of claim 9 further comprising the hinge being a base hinge.

12. A sliding combination tool kit mounted upon a tool support comprising:
a) the combination tool kit having a sliding sleeve;
b) the sliding sleeve being cylindrical in shape and hollow inside;
c) the sliding sleeve having a gripping area on its outer perimeter;
d) the sliding sleeve having at least one open end; and
e) the tool support having a ratchet drive and a straight hex socket oppositely disposed from each other.

13. The sliding combination tool of claim 12 further comprising:
a) the ratchet drive having a square drive and a hex socket oppositely disposed from each other;
b) the square drive being able to accommodate at least one socket;
c) the hex socket being able to accommodate at least one bit;
d) the straight hex socket being able to accommodate the at least one bit;
e) a diameter of the tool support being less than that of the sliding sleeve; and
f) the tool support being able to slide into and out of the sliding sleeve.

14. The sliding combination tool kit of claim 13 further comprising:
a) the sliding sleeve having a first open end and a second open end oppositely disposed from each other;
b) the sliding sleeve having a at least one pair of locking apertures; and
c) the sliding combination tool support having a sliding combination ratchet drive and a sliding combination straight hex socket oppositely disposed from each other.

15. The sliding combination tool kit of claim 14 further comprising:
a) the sliding combination ratchet drive having a sliding combination square drive and a sliding combination hex socket oppositely disposed from each other;
b) the sliding combination square drive being able to accommodate at least one sliding combination socket;
c) the sliding combination hex socket being able to accommodate at least one sliding combination bit; and
d) the sliding combination straight hex socket being able to accommodate the at least one sliding combination bit.

16. The sliding combination tool kit of claim 15 further comprising:
a) a diameter of the sliding combination tool support being less than that of the sliding sleeve;
b) the length of the sliding combination tool support being such that the sliding sleeve is long enough to cover either the sliding sleeve ratchet drive or the sliding sleeve straight hex socket;
c) the sliding combination tool support having a at least one pair of locking buttons; and
d) the sliding combination tool support sliding through the sliding sleeve.

17. The sliding combination tool kit of claim 16 further comprising:
a) the at least one pair of locking buttons cooperating with the at least one pair of locking apertures; and
b) the locking buttons pushing through the locking apertures to for a stable connection.

18. The sliding combination tool kit of claim 17 further comprising:
a) the combination tool kit being a blind end combination tool kit;
b) the sliding sleeve being a blind end sliding sleeve;
c) the blind end sliding sleeve having a blind end and a blind end and a blind end tool aperture oppositely disposed from each other;
d) the blind end being closed;
e) the blind end sliding sleeve having an inner lining with a hexagonal cross section;
f) the tool support being a blind end tool support;
g) the blind end tool support having a hexagonal tool support body; and
h) the ratchet drive being a blind end ratchet drive and the straight hex socket being a blind end straight hex socket.

19. The sliding combination tool kit of claim 18 further comprising:
a) the blind end ratchet drive having a blind end square drive and a blind end hex socket oppositely disposed from each other;
b) a diameter of the blind end combination tool support being less than that of the blind end sliding sleeve;
c) the length of the blind end combination tool support being such that the blind sliding sleeve is long enough to cover either the blind end ratchet drive or the blind end straight hex socket;
d) the blind end square drive being able to accommodate at least one blind end socket; and
e) the blind end hex socket being able to accommodate at least one blind end bit.

20. The sliding combination tool kit of claim 19 further comprising:
a) the blind end straight hex socket being able to accommodate blind end bits;
b) the inner lining cooperating with hexagonal tool support body to form a secure attachment;
c) the diameter of blind end ratchet drive and blind end straight hex socket being less than that of the inner lining;
d) the blind end tool support aligning with the inner lining; and
e) the blind end tool support sliding into the blind end sliding sleeve.
